(19) United States
(12) Patent Application Publication
(10) Pub. No.: US 2006/0215223 A1
(43) Pub. Date: Sep. 28, 2006

(54) Book with compressible object

(76) Inventor: Melanie L. Gerth, Frisco, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 11/087,164

(22) Filed: Mar. 23, 2005

(51) Int. Cl. G06K 15/00

(52) U.S. Cl. 358/1.18

(57) ABSTRACT

A printed article containing a plurality of pages disposed between a front cover page and a rear cover page. An object is disposed on and protrudes from one or more of the plurality of pages. At least a portion of the object contains a soft flexible exterior forming an interior pocket. A plush material is disposed in the pocket so that at least a portion of the object is compressible. One or more of the pages that are bound between the object and the front cover page contains a cut-out region that is aligned with the object so that when the printed article is closed, the object extends through the cut-out region.

### TECHNICAL FIELD OF THE INVENTION

This invention relates to a printed or sewn article such as a book, and more particularly, to a printed or sewn article having a compressible object attached to one or more pages, the pages having a cut-out region in general alignment with the object such that when the pages are turned, one or more of the objects disappears from the reader's view.

### BACKGROUND OF THE INVENTION

Numerous books are continually developed with features designed to attract the interest of children. For example, books have been developed to include interactive stickers, while other books include sound or light generators to give visual or auditory interactions. Books have been given irregular shapes to resemble various symbols, characters or animals. Books have included a variety of paper pop-up or pull-out illustrations or figures to attract and interest the child. Still other books have incorporated a toy or figurine in some fashion within the confines of the book. Despite all the prior variations in books including three dimensional figurines, other variations are continually sought, to help promote the use and reading of children's books, or to serve as an appealing advertisement or promotion.

### SUMMARY OF THE INVENTION

The present invention relates to a printed or sewn article, such as a book or magazine, comprising a plurality of pages between a front cover and rear cover. At least one object is disposed on at least one page of the printed or sewn article (an object page). According to an embodiment of the present invention, the object comprises a soft and flexible exterior forming an interior pocket to receive a plush or otherwise flexible material so that the object is soft, cushion-like, and compressible to attract the reader's attention.

One or more of the preceding pages disposed between the object page and the front cover page contains a cut-out region. For each object, the cut-out region is positioned on the preceding page(s) in the same relative location as the object on the object page so that when the book is in the closed position, the object is aligned with and can extend through the cut-out region(s). Accordingly, as the pages are turned in the printed article, the object disposed on the “turned” object page will disappear from the reader's view and any object(s) remaining on the unturned object page(s) will remain visible through the cut-out regions.

### BRIEF DESCRIPTION OF THE DRAWINGS

For a more complete understanding of the present invention and the advantages thereof, reference is now made to the following description of the Preferred Embodiments taken in conjunction with the accompanying Drawings in which:

FIG. 1 is a perspective view of the front cover of the printed article;

FIG. 2 is a perspective view of the printed article in the open position;

FIG. 3 is a section view of the printed article in FIG. 1 taken along the line 3-3;

FIG. 3a is an enlarged view of the object in FIG. 3;

FIG. 4 is a front elevational view of the printed article in the open position illustrating the flexible objects disposed on a page; and

FIG. 5 is a front elevational view of the printed article in the open position illustrating the flexible objects after a page of the printed article in FIG. 4 has been turned.

### DESCRIPTION OF THE PREFERRED EMBODIMENTS

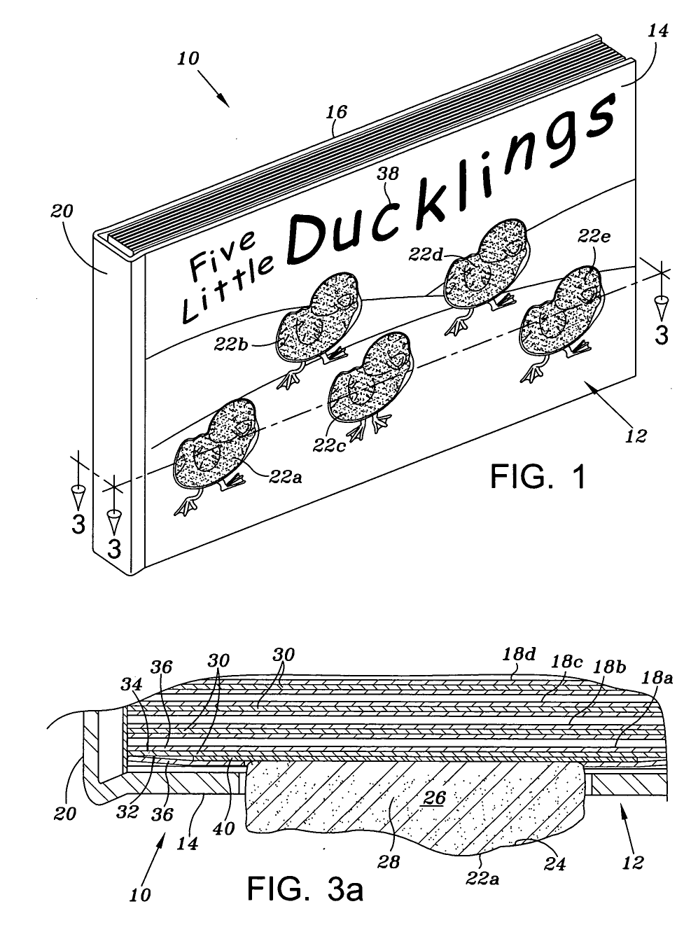

FIGS. 1-3 are diagrams of a printed article 10 in accordance with the present invention. In the embodiments illustrated in FIGS. 1-3, printed article 10 comprises a cover 12 having a front cover page 14, a rear cover page 16 and a plurality of pages 18a-18f disposed between the front and rear cover pages 14 and 16. Pages 14, 16 and 18a-18f are joined together at a spine 20 and comprise compressible objects 22a-22e respectively. Printed article 10 can include any article that contains printed, written, painted or sewn material thereon, such as a book, a magazine, a pamphlet, a brochure, or any other similar article and can be fabricated from any material such as paper, plastic, cloth or the like.

FIG. 3a is an enlarged diagram of object 22a of printed article 10. In the embodiment illustrated in FIG. 3a, object 22a comprises a sidewall 24 forming a pocket area 26 for holding air or a soft-like plush material 28. Plush material 28 can be any cushiony/compressible material such as cotton, down, feathers, or the like, to permit deflection of sidewall 24 when a force is applied thereto. Sidewall 24 is fabricated from a soft cloth-like material such as cotton, nylon, satin, spandex or a flexible plastic. Object 22a can represent any type of object, symbol, character, or animal. Accordingly, object 22a serves to enhance interest in printed article 10 as a result of its size, shape and feel. While FIG. 3a illustrates object 22a, it should be understood that object 22a is an exact representation of objects 22b-22e.

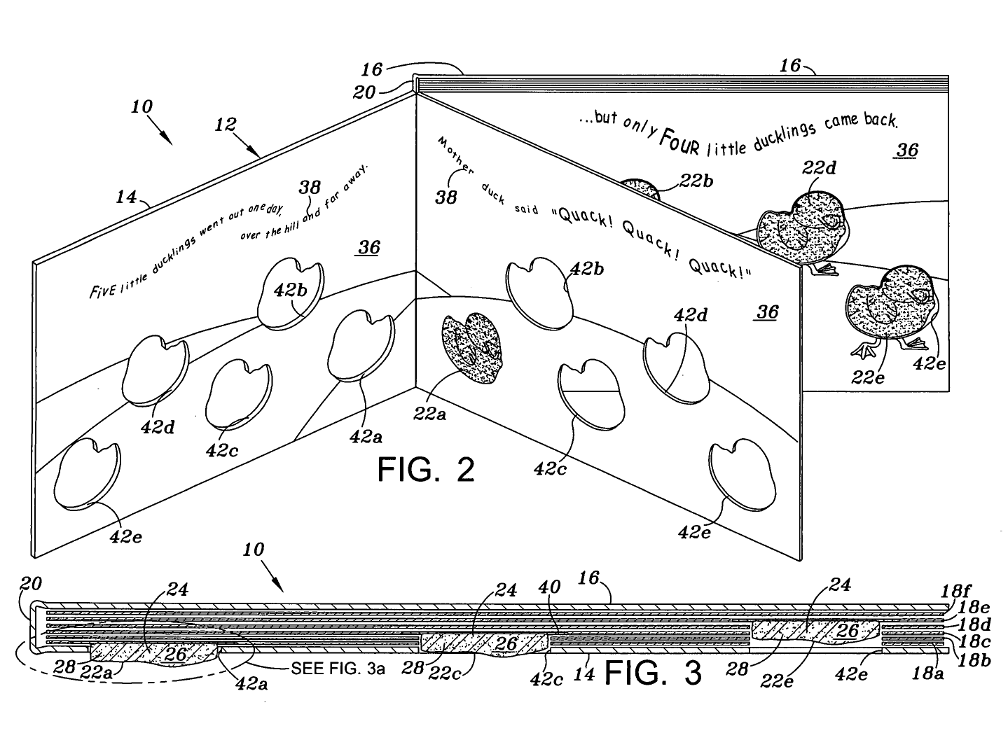

According to the embodiment illustrated in FIGS. 3 and 3a, pages 18a-18f include a substantially rigid base or board member 30 comprising a front side 32 and a rear side 34 to provide rigidity to pages 18a-f. A paper member 36, which contains printed material 38 (FIG. 2), is attached to front side 32 and/or rear side 34 of board member 30. It should be understood that printed material can include any type of writing or illustration that is either printed, written, painted or sewn thereon. Alternatively, printed material 38 can be printed directly on either side of board member 30 in order to omit the need for paper member 36, if desired.

According the embodiment illustrated in FIGS. 3 and 3a, objects 22a-22e are securely fastened to pages 18a-18e by use of a footing 40. Footing 40 is formed from cloth, plastic, paper or any other material that is suitable for fastening to pages 18a-18f. Objects 22a-22e are securely fastened to footing 40 by using an adhesive, although it should be realized by one of ordinary skill that any means of attachment can be used, such as stitching or the like. Once objects 22a-22e are attached to footings 40, footings 40 are secured to pages 18a-18e by placing the footing 40 between board member 30 and paper member 36. The footing 40 is adhesively attached to board member 30 and/or paper member 36 so that footing 40 is concealed beneath page member 36 and objects 22a-22e protrude from paper member 36.

When printed article 10 and/or pages 18a-18e are fabricated from a cloth material, objects 22a-22e can be securely fastened directly to pages 18a-18e by stitching, an adhesive, or the like. Accordingly, footing 40 can be omitted therefrom.

According to one embodiment of the present invention, objects 22a-22e are fabricated as stand-alone objects. That is, when objects 22a-22e are detached from printed article 10, objects 22a-22e would still be recognizable as the item they are depicting (i.e., the symbol, character, animal, etc.) separately from printed article 10. [0018] Referring specifically to the embodiments illustrated in FIGS. 1-3, each object 22a-22e is aligned with cut-out regions 42a-42e disposed on the preceding pages. The term preceding pages, as used herein, means one or more pages 18a-18e positioned between a page containing an object 22a-22e (an object page) and front cover page 14, with the one or more pages disposed directly adjacent to each other beginning from the object page. Referring to FIGS. 2 and 3, for example, all preceding pages 18a-18d, including front cover page 14, contain a cut-out region 42e so that when the book is in the closed position (FIGS. 1 and 3), object 22e can be observed and touched by the reader.

According to yet another embodiment of the present invention, the shape of cut-out regions 42a-42e can resemble and follow the outline of objects 22a-22e, respectively, so that as objects 22a-22e extend through and/or are observed through cut-out regions 42a-42e, each object will appear to be attached to and part of each preceding page. Objects 22a-22e are chosen to form a cooperative storyline with printed material 38.

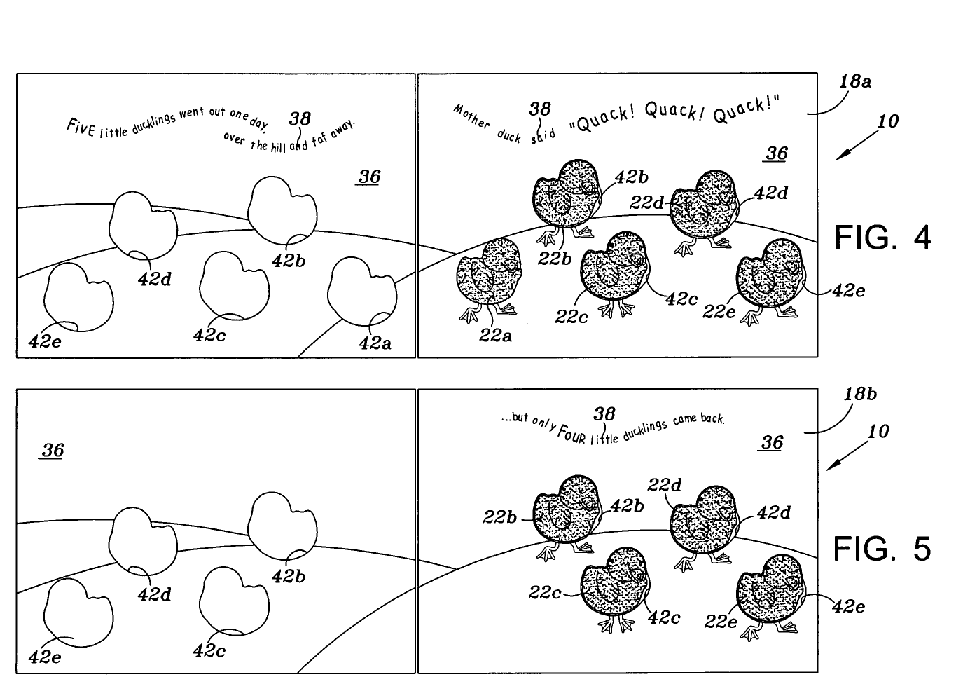

FIGS. 4 and 5 illustrate printed article 10 in the open position with objects 22a-22e in view of the reader. According to the embodiments illustrated in FIGS. 4 and 5, object 22a is disposed on object page 18a and the remaining objects 22b-22e are aligned with cut-out regions 42b-42e. While object page 18a contains only one object 22a directly attached thereto, printed material 38 provides the illusion that objects 22b-22e are also disposed on object page 18a. As object page 18a is turned, object 22a disappears and four objects 22b-22e remain. As additional pages 18b-18e are turned, additional objects 22b-22e will disappear respectively from the reader's view in accordance with the printed material on pages 38.

While the present invention comprises a single object 22a-22e per page 18a-18e, it should be realized by one of ordinary skill that a plurality of objects can be attached to or omitted from any page. Furthermore, while the present invention illustrates pages 18a-18f, a greater or few number of pages 18a-18f and objects 22a-22e can be incorporated, if desired.

Other alterations and modifications of the invention will likewise become apparent to those of ordinary skill in the art upon reading the present disclosure, and it is intended that the scope of the invention disclosed herein be limited only by the broadest interpretation of the appended claims to which the inventor is legally entitled.

What is claimed is:

1. A printed article comprising:
a plurality of pages between a front cover page and a rear cover page;
an object disposed on and protruding from one or more of said plurality of pages, wherein a portion of said object is compressible; and
wherein one or more of said pages disposed between said object and said front cover page contains a cut-out region around said object.

2. The printed article of claim 1 wherein said object is fabricated from a fabric material.

3. The printed article of claim 1 wherein said object is fabricated from a plastic material.

4. The printed article of claim 2 wherein said fabric material forms a pocket, wherein a plush material is disposed inside said pocket so that at least a portion of said object is cushiony.

5. The printed article of claim 4 wherein said plush material is cotton.

6. The printed article of claim 2 wherein said fabric material forms a pocket, wherein air is disposed inside said pocket so that at least a portion of said object is cushiony.

7. The printed article of claim 1 wherein said cut-out region follows the outline of said object.

8. The printed article of claim 1 wherein said object protrudes through said cut-out regions.

9. The printed article of claim 1 wherein all of said pages between said front cover page and said object contain a cut-out region around said object.

10. The printed article of claim 9 wherein said front cover page contains a cut-out region aligned with said object.

11. The printed article of claim 1 wherein said plurality of pages contain printing thereon that forms a cooperative storyline with said object.

12. The printed article of claim 1 wherein said object contains a footing, wherein said footing is securely fastened to one of said plurality of pages.

13. The printed article of claim 12 wherein said footing is fabricated from a flexible material.

14. The printed article of claim 1 wherein said plurality of pages contains a base member having a front side and a rear side, wherein a paper member having printed subject matter is attached to said front side of said board member.

15. The printed article of claim 14 wherein said object is securely fastened to a footing wherein said footing is disposed between said base member and said paper member to securely fasten said object to one of said plurality of pages.

16. The printed article of claim 1 wherein said printed article is fabricated from cloth.

17. A printed article comprising:
a plurality of pages joined together between a front cover page and a rear cover page;
an object disposed on and protruding from one or more of said plurality of pages, said object containing a flexible sidewall forming an interior pocket for receiving a plush material so that at least a portion of said object is compressible; and
wherein one or more of said pages disposed between said object and said front cover page contains a cut-out region around said object so that said object can extend therethrough.

18. The printed article of claim 17 wherein said object is fabricated from a fabric material.

19. The printed article of claim 17 wherein said object is fabricated from a flexible plastic material.
